(19) United States
(12) Patent Application Publication
(10) Pub. No.: US 2020/0341728 A1
(43) Pub. Date: Oct. 29, 2020

(54) INFORMATION PROCESSING SYSTEM AND NON-TRANSITORY RECORDING MEDIUM

(71) Applicant: Konica Minolta, Inc., Tokyo (JP)

(72) Inventor: Teppei Nakamura, Toyokawa-shi (JP)

(73) Assignee: Konica Minolta, Inc., Tokyo (JP)

(21) Appl. No.: 16/844,309

(22) Filed: Apr. 9, 2020

(30) Foreign Application Priority Data
Apr. 25, 2019 (JP) 2019-083604

(51) Int. Cl. G06F 3/16; G06F 3/0484

(52) U.S. Cl. CPC G06F 3/167; G06F 3/0484

(57) ABSTRACT

An information processing system includes: a display; and a hardware processor that: receives user's voice as a voice operation; updates a screen to be displayed on the display based on the received voice operation; determines whether to display the updated screen on the display; and displays the updated screen on the display unit upon determining to display the updated screen.

### CROSS-REFERENCE TO RELATED APPLICATIONS

Japanese patent application No. 2019-083604 filed on Apr. 25, 2019 including description, claims, drawings, and abstract the entire disclosure is incorporated herein by reference.

### BACKGROUND

### Technical Field

The present invention relates to an information processing system and a non-transitory recording medium. The present invention more specifically relates to a technique that provides a user with feedback of information that reflects a voice operation performed by the user.

### Description of the Related Art

Recently, a voice input device so called AI speaker, for instance, has been increasingly more popular. This type of the voice input device has a wired or wireless connection to a network. The voice input device is enabled to communicate with an image processing device that processes various types of jobs including a print job over the network. The image processing device may be one of MFPs (Multifunction Peripherals), for instance. A user voices to the voice input device so that he or she is enabled to operate the image processing device to configure a job setting in a remote location from the image processing device. This type of voice input device is also capable of outputting voice. The image processing device, therefore, is capable of providing the user with feedback of the information that reflects the voice operation by the user via the voice input device as speech. The user talks with the voice input device and confirms setting values for the respective setting items to proceed the setting operation.

When the image processing device proceeds the setting of the job based on the voice operation by the user, it may not be sufficient just to provide the user with speech feedback. In other words, the voice input device cannot provide the user with feedback of enough information just by outputting the voice. It is assumed, for example, the user instructs adjustment of an image quality of an image. In this case, the voice input device cannot tell the user the image that reflects the image quality adjustment by speech. It is further assumed, for example, the user instructs a cancellation of a registered job while multiple jobs have been registered with the image processing device. In this case, the image processing device needs to give a guidance about the details of the multiple jobs registered with the image processing device through the voice output by the voice input device in order to identify the registered job that the user would like to cancel. When there are many jobs registered with the image processing device, the voice output from the voice input device becomes long. It is difficult for the user to understand the long voice and he or she cannot instruct the job to cancel.

As a technique of remotely operating the image processing device by voice as described above, a technique to use a terminal device communicable with the image processing device is known. This known technique is introduced for example in Japanese Patent Application Laid-Open No. JP 2015-166912 A. According to the known technique, the image processing device sends image data of a screen displayed on an operational panel of the image processing device to the terminal device, and the terminal device extracts a text contained in the image data. Once detecting the voice of the user, the terminal device converts the detected voice into a text, and cross references the text extracted from the image data. When the text converted from the voice matches with the text extracted from the image data, the terminal device identifies a position that includes the text in the screen and sends information showing the identified position to the image processing device so that it may remotely operate the image processing device.

Even with the known technique, the user cannot be provided with accurate feedback of contents of the updated screen when the screen displayed on the operational panel is updated based on the voice of the user. It is assumed, for example, a screen showing a preview of the image, the quality of which had been adjusted, is displayed on the operational panel of the image processing device based on the user instruction. In this case, even though the terminal device extracts the text from the previewed image, the terminal device cannot accurately provide the user with feedback of the detail of the previewed image.

### SUMMARY

One or more embodiments of the present invention provide an information processing system and a non-transitory recording medium that provide a user with accurate information for feedback even when it is difficult to provide the user with feedback by voice while the user is performing voice operations.

First, one or more embodiments of the present invention are directed to an information processing system.

According to one or more embodiments of the present invention, the information processing system comprises: a display unit (or display); and a hardware processor that: receives user's voice as a voice operation; updates a screen to display on the display unit based on the received voice operation; determines whether or not to display the updated screen on the display unit; and displays the updated screen on the display unit upon determining to display the updated screen on the display unit.

Second, one or more embodiments of the present invention are directed to a non-transitory recording medium storing a computer readable program to be executed by a hardware processor in a computer comprising a display unit.

According to one or more embodiments of the present invention, the non-transitory recording medium stores the computer readable program, execution of the computer readable program by the hardware processor causing the hardware processor in the computer to perform: receiving user's voice as a voice operation; updating a screen to display on the display unit based on the received voice operation; determining whether or not to display the updated screen on the display unit; and displaying the updated screen on the display unit upon determining to display the updated screen on the display unit.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary conceptual configuration of an information processing system according to one or more embodiments of the present invention;

FIGS. 2A and 2B illustrate an exemplary structure of an image processing device according to one or more embodiments;

FIG. 3 illustrates a block diagram showing an example of the hardware structure of the information processing system according to one or more embodiments;

FIG. 4 illustrates a block diagram showing an example of the functional structure of a controller of the image processing device according to one or more embodiments;

FIG. 5 illustrates a flow diagram explaining an exemplary procedure of a process performed by the image processing device according to one or more embodiments;

FIG. 6 illustrates a flow diagram explaining a first exemplary procedure of a screen determination according to one or more embodiments;

FIG. 7 illustrates a flow diagram explaining a second exemplary procedure of the screen determination according to one or more embodiments;

FIG. 8 illustrates an example of a preview screen according to one or more embodiments;

FIG. 9 illustrates an example of a thumbnail screen according to one or more embodiments;

FIG. 10 illustrates an example of a job list screen according to one or more embodiments;

FIG. 11 illustrates an example of an address selecting screen according to one or more embodiments;

FIG. 12 illustrates an example of an advanced setting screen according to one or more embodiments;

FIG. 13 illustrates an example of a screen when a quality of an image is adjusted according to one or more embodiments;

FIG. 14 is an example of a post processing setting screen according to one or more embodiments;

FIG. 15 is an example of a screen to configure a setting of a ground tint or a watermark according to one or more embodiments;

FIG. 16 illustrates a flow diagram explaining an exemplary procedure of a user status determination according to one or more embodiments;

FIG. 17 illustrates a flow diagram explaining an exemplary procedure of a screen display according to one or more embodiments;

FIG. 18 illustrates an example of a check screen according to one or more embodiments;

FIGS. 19A and 19B illustrate a concept of highlighting the screen according to one or more embodiments;

FIG. 20 illustrates an exemplary conceptual configuration of the information processing system according to one or more embodiments; and

FIG. 21 illustrates an exemplary conceptual configuration of the information processing system according to one or more embodiments.

### DETAILED DESCRIPTION OF EMBODIMENTS

Hereinafter, embodiments of the present invention will be described with reference to the drawings. However, the scope of the invention is not limited to the disclosed embodiments.

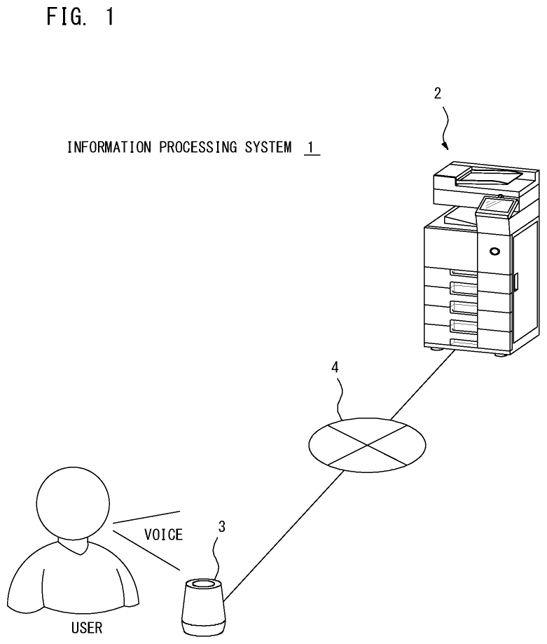

FIG. 1 illustrates an exemplary conceptual configuration of an information processing system 1 according to one or more embodiments of the present invention. The information processing system 1 includes an image processing device 2 constructed by a device such as one of MFPs and a voice input device (or voice input unit) 3 such as an AI speaker. The image processing device 2 and the voice input device 3 are connected to enable communication with each other over a network 4 such as LAN (Local Area Network). The network 4 may be either of a wired network or a wireless network. The other devices such as personal computers that are not shown in FIG. 1 may also be connected to the network 4.

The image processing device 2 includes multiple functions such as a scan function, a print function, a copy function, a fax function, a box function and/or an email transmission and receipt function, for instance. The image processing device 2 processes a job specified by a user. When the copy function is selected by the user, for instance, the image processing device 2 configures various types of settings relating to the copy function based on the user instruction. Once the user instructs to process the job, the image processing device 2 starts processing the copy job. The box function is to store electronic files such as image data in a predetermined storage area.

The voice input device 3 is installed at a location apart from the image processing device 2, for example. The voice input device 3 is enabled to work together with the image processing device 2. To be more specific, the voice input device 3 is equipped with a function to remotely operate the image processing device 2 based on a user's voice. In response to detecting the user's voice, the voice input device 3 generates voice information based on the detected voice and sends the generated voice information to the image processing device 2.

Once receiving the voice information from the voice input device 3, the image processing device 2 accepts the user's voice corresponding to the voice information as a voice operation. The image processing device 2 reflects the voice operation to the inside of the device. It is assumed, for example, the voice operation performed by the user is to configure the job setting. In this case, the image processing device 2 processes the job specified by the user.

When performing a process based on the voice information received from the voice input device 3, the image processing device 2 generates the voice information to provide the user with feedback of a result of the process. The image processing device 2 then sends the generated voice information to the voice input device 3. In response to receiving the voice information for feedback to the user from the image processing device 2, the voice input device 3 outputs a voice based on the voice information from a speaker. Even when the user is at a location apart from the image processing device 2, he or she is enabled to configure the job setting with the image processing device 2 by talking to the voice input device 3.

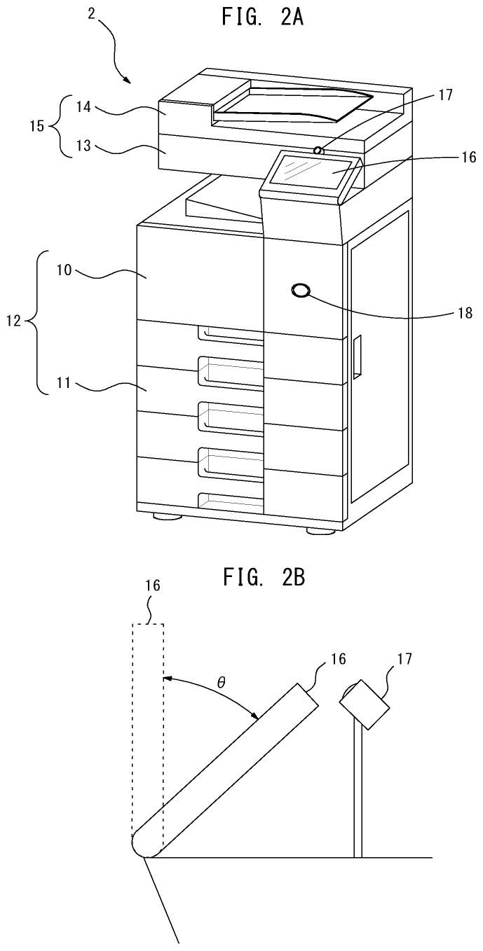

FIGS. 2A and 2B illustrate an example of the image processing device 2. As illustrated in FIG. 2A, the image processing device 2 includes a printer section (or printer) 12 in a lower part of the device body. The printer section 12 includes an image forming unit 10 and a sheet feeding unit 11. The printer section 12 prints on a sheet such as a printing sheet. A bundle of multiple numbers of sheets are stored in the sheet feeding unit 11, and the sheet feeding unit 11 feeds out each sheet toward the image forming unit 10 during the processing of the print job and/or the copy job. The image forming unit 10 transfers and fixes a toner image on the sheet fed by the sheet feeding unit 11 so that an image that is an object of printing is printed on the sheet.

The image processing device 2 includes a scanner section 15 in an upper part of the device body. The scanner section 15, for example, includes an image reader 13 and an automatic document conveyance unit 14. The image reader 13 optically reads an image of a document, and the automatic document conveyance unit 14 automatically conveys the document. When processing of the scan job or the copy job is instructed by the user, the automatic document conveyance unit 14 takes out each sheet of the document placed by the user and automatically conveys to a reading position of the image reader 13. The image reader 13 reads an image of the document when the document conveyed by the automatic document conveyance unit 14 passes through the reading position, and generates image data.

The image processing device 2 is provided with an operational panel 16 on a front side of the scanner 15. The operational panel 16 is a user interface for the user to operate the image processing device 2. The operational panel 16 displays various types of screens operable for the user and accepts operations from the user. The operational panel 16 is enabled to accept both of the manual operations performed by the user through the various types of screens and the voice operations by the user. A photographing unit (photographing device) 17 to photograph a face image of the user who operates the operational panel 16 is provided near the operational panel 16.

FIG. 2B illustrates the operational panel 16 in side view. The operational panel 16 is rotatable on a rotary axis extending to a right-to-left direction of the device body. The operational panel 16 is enabled to change its posture. The operational panel 16, for instance, is enabled to change its posture within a range of a predetermined angle θ. The operational panel 16 displays the various types of screens toward the direction corresponding to the posture. The user changes the posture of the operational panel 16 corresponding to his or her height or posture for operating the operational panel 16 so that it is easier for the user to see the various types of screens.

As illustrated in FIG. 2A, the image processing device 2 is equipped with a human detection sensor 18 on a front side of the device body. The human detection sensor 18 detects a human existing within a range of a predetermined distance in the front side of the image processing device 2. The human detection sensor 18 is formed from an infrared sensor, for instance.

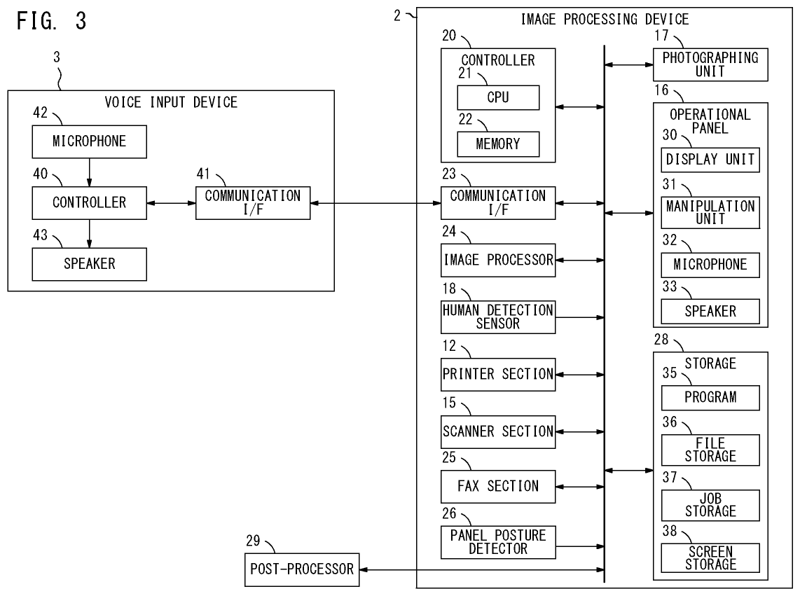

FIG. 3 illustrates a block diagram showing an example of the hardware structure of the information processing system 1. As the hardware structure, the voice input device 3 includes a controller 40, a communication interface 41, a microphone 42 and a speaker 43. The controller 40 includes a CPU and a memory which are not shown in FIG. 3. The controller 40 controls operations of each part. The communication interface 41 connects the voice input device 3 to the network 4 to enable communication with the image processing device 2. The microphone 42 detects the user's voice and microphone 42 outputs the voice information based on the detected user's voice. The controller 40 then sends the voice information to the image processing device 2 via the communication interface 41. The image processing device 2 then performs a process based on the user's voice. After receiving the voice information for feedback to the user from the image processing device 2 via the communication interface 41, the controller 40 drives the speaker 43 based on the voice information to output the voice from the speaker 43. It is assumed, for example, the user changes a setting value of a setting item of a job from a default value by voice. The voice information corresponding to the changed setting value is output from the image processing device 2. The controller 40 outputs the voice based on the voice information from the speaker 43 to enable the user to confirm whether or not the setting value designated by himself or herself is correctly configured with the image processing device 2. Hence, the user is enabled to remotely operate the image processing device 2 by talking with the voice input device 3.

As the hardware structure, the image processing device 2 includes a controller 20 (or a hardware processor), a communication interface 23, an image processor 24, a fax section 25, a panel posture detector 26 and a storage 28 besides the above-described printer section 12, scanner section 15, operational panel 16, photographing unit 17 and human detection sensor 18. The controller 20 controls the respective parts/sections of the image processing device 2 so that they operate appropriately. Each part is enabled to input and output data to and from each other over an internal bus. The image processing device 2 can also connect a post processor 29 to the internal bus. The post processor 29 takes the printed sheet output from the printer section 12 and performs a post processing such as stapling and/or punching to the sheet.

The operational panel 16 includes a display unit (or display) 30, a manipulation unit 31, a microphone 32 and a speaker 33. The display unit 30 is constructed by a device such as a color liquid crystal display, for instance. A variety of screens operable for the user are displayed on the display unit 30. The manipulation unit 31 detects a manual operation by the user. The manipulation unit 31 is constructed by parts such as a touch panel sensor arranged on the display area of the display unit 30 and/or push-button keys arranged around the display area of the display unit 30. The microphone 32 detects the voice of the user who operates the operational panel 16 and generates the voice information. The speaker 33 outputs a variety of guidance to the user by voice.

When the human detection sensor 18 does not detect any human within a range of the predetermined distance in the front side of the image processing device 2, for example, the operational panel 16 may stop power supply to the display unit 30 and terminate a screen display function. In this case, even when the activation of the screen display function of the operational panel 16 is terminated, the screen to be displayed on the display unit 30 is updated in response to the user operation inside the image processing device 2 if the user remotely operates the image processing device 2 by voice.

The controller 20 includes a CPU 21 and a memory 22. The controller 20 controls operations of each part. The CPU 21 reads and executes a program 35 stored in the storage 28. The memory 22 stores temporary data generated when the CPU 21 executes the program 35. The CPU 21 executes the program 35 so that the controller 20 serves as various types of processing parts which are described later.

The communication interface 23 connects the image processing device 2 to the network 4, and communicates with another device connected to the network 4. The communication interface 23, for instance, receives the voice information sent from the voice input device 3 and/or sends the voice information output from the controller 20 to the voice input device 3.

The image processor 24 processes various types of image processing on the image data. The image processor 24 is enabled to perform an image quality adjustment to change the tone of colors of a color image. The image processor 24 is also enabled to perform a process to superimpose an image designated by the user on the image data as a ground tint or a watermark.

The fax section 25 transmits and receives fax data over public phone lines, which are not shown in FIG. 3. When the user designates fax transmission, the fax section 25 generates fax data based on image data which is an object of transmission, and sends the fax data to an address specified by the user.

The panel posture detector 26 detects the posture of the operational panel 16. As described above, the operational panel 16 is capable of changing its posture to any posture within a range of the predetermined angle θ. The panel posture detector 26 detects the posture (angle) of such operational panel 16.

The storage 28 is formed from a non-volatility device such as a hard disk drive (HDD) or a solid-state drive (SDD), for example. The program 35 as described above is stored in advance in the storage 28. The storage 28 includes a file storage 36, a job storage 37 and a screen storage 38 as a storage area to store various types of data.

The file storage 36 is a storage area used by the box function. More specifically, electronic files such as image data and/or document data are stored in the file storage 36. Multiple electronic files may be stored in the file storage 36. The controller 20, for example, stores the electronic file designated by the user in the file storage 36 when an operation to register the electronic file is performed by the user.

The job registered by the user is stored in the job storage 37. Multiple registered jobs may be stored in the job storage 37. In response to receiving the operation to register the job by the user, the controller 20 stores the job specified by the user as the registered job in the job storage 37.

Information relating to the screen to display on the display unit 30 (screen information) is stored in the screen storage 38. When the controller 20 receives the user's voice as the voice operation, for example, it updates the screen to display on the display unit 30 of the operational panel 16. If the activation of the screen display function of the display unit 30 has been terminated, the updated screen cannot be displayed on the display unit 30. In this case, the controller 20 stores and manages the screen information relating to the screen updated based on the user operation in the screen storage 38.

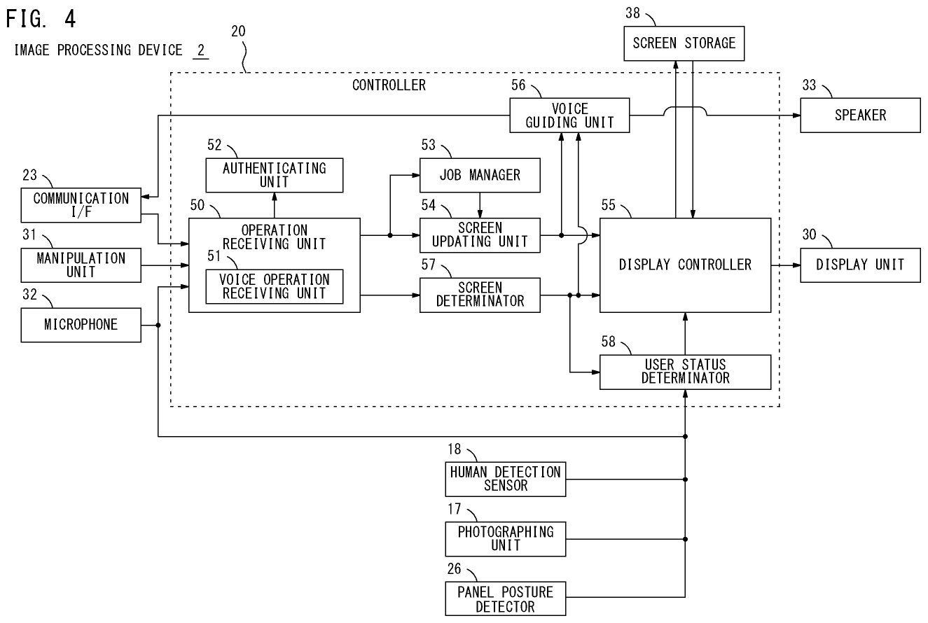

FIG. 4 illustrates a block diagram showing an example of the functional structure of the controller 20 of the image processing device 2. The CPU 21 of the controller 20 executes the program 35 so that the controller 20 serves as an operation receiving unit 50, a user authenticating unit 52, a job manager 53, a screen updating unit 54, a display controller 55, a voice guiding unit 56, a screen determinator 57 and a user status determinator 58.

The operation receiving unit 50 receives the user operation. The operation performed by the user to the image processing device 2 has two types, the manual operation and the voice operation. The operation receiving unit 50 is capable of receiving both two types of the operations. It is assumed, for instance, the user operates the manipulation unit 31 of the operational panel 16 by manual, the operation receiving unit 50 receives the operation as the manual operation by the user based on operation information output from the manipulation unit 31. The operation receiving unit 50 includes a voice operation receiving part 51. The voice operation receiving part 51 receives the user's voice as the voice operation. When receiving the voice information output from the voice input device 3 via the communication interface 23, for example, the voice operation receiving part 51 receives the user's voice based on the voice information as the voice operation. When obtaining the voice information output from the microphone 32 equipped with the operational panel 16, the voice operation receiving part 51 is also capable of receiving the user's voice based on the voice information as the voice operation.

The user authenticating unit 52 authenticates the user who is trying to use the image processing device 2. The user authenticating unit 52 obtains the operation information or the voice information from the operation receiving unit 50, and authenticates based on the obtained information. The user authenticating unit 52, for example, cross references a user ID and/or a password input through the manipulation unit 31 of the operational panel 16 and authentication information registered in advance, thereby performing an authentication of the user. The user authenticating unit 52 also extracts voice information in the voice information based on the user's voice, and cross references the voiceprint and voiceprint information registered in advance, thereby performing a voiceprint authentication. When the authentication results in success, the user authenticating unit 52 may identify the user who is trying to use the image processing device 2. If the authentication results in success while the user has been logged out from the image processing device 2, the user authenticating unit 52 authorizes the user who is identified through the authentication as a log-in user. The user authenticating unit 52 then shifts the image processing device 2 to a log-in state operable for the log-in user. As a result, the user is enabled to perform the job setting operation and/or give the job processing instruction to the image processing device 2.

It is assumed that, for example, the voice operation receiving part 51 receives the voice information from the voice input device 3 after the image processing device 2 is shifted to the log-in state. In this case, the voice operation receiving part 51 performs a voice recognition based on the voice information. In the voice recognition, a process to extract a word spoken by the user is performed. When the word spoken by the user is extracted in the voice recognition, the voice operation receiving part 51 determines if the extracted word matches with a keyword for voice operation registered in advance. When the extracted word matches with the keyword for voice operation, the voice operation receiving part 51 is enabled to identify a process that should be performed by the image processing device 2. Hence, when the extracted word matches with the keyword for voice operation, the voice operation receiving part 51 receives the voice information received from the voice input device 3 as the voice operation. The voice operation receiving part 51 outputs the keyword for voice operation which is matched with the extracted word to each of the job manager 53 and the screen updating unit 54.

The job manager 53 manages the job. The job manager 53 configures the setting of the job and/or controls the processing of the job based on the keyword for voice operation output from the voice operation receiving part 51. When the user specifies to register the job as the registered job, the job manager 53 stores and manages the registered job which reflects the job setting based on the voice operation in the job storage 37. It is assumed, for example, that the user instructs to adjust the image quality of the image data. In this case, the job manager 53 brings the image processor 24 into operation to enable the image processor 24 to adjust the image quality as instructed by the user. It is assumed, for example the user instructs to superimpose the ground tint or the watermark on the image data. In this case, the job manager 53 brings the image processor 24 into operation to enable the image processor 24 to superimpose the image designated by the user on the image data as the ground tint or the watermark.

The screen updating unit 54 generates the screen to display on the display unit 30 and updates the screen in response to the user's operation one by one. The screen updating unit 54 updates the screen to display on the display unit 30 based on the keyword for voice operation received from the voice operation receiving unit 51. When the user, for example, selects the copy function, the screen updating unit 54 creates a setting screen for the setting of the job relating to the copy function as the screen to display on the display unit 30. Once the setting item included in the setting screen is changed by the user, the screen updating unit 54 changes the setting value of the setting item to a value specified by the user from a default value, and updates the setting screen. When the user instructs a preview screen of an image, the screen updating unit 54 creates a preview screen displaying a preview of the image designated by the user. The user may then instruct to adjust the quality of the previewed image. In such a case, the screen updating unit 54 changes the image to preview to an image, the quality of which is adjusted by the image processor 24, and updates the preview screen. As described above, the screen updating unit 54 updates the screen to display on the display unit 30 based on the user instruction one by one. The screen updating unit 54 then outputs the screen information to the display controller 55.

The display controller 55 controls a display of the screen on the display unit 30. When the screen display function of the display unit 30 is effectively activated, the display controller 55 displays the screen on the display unit 30 based on the screen information received from the screen updating unit 54. The user is enabled to operate the image processing device 2 looking at the screen displayed on the display unit 30. While the image processing device 2 is remotely operated by the user by the voice input to the voice input device 3, the display controller 55 may terminate activating the screen display function of the display unit 30. In such a case, even when the screen information is obtained from the screen updating unit 54, the display controller 55 does not display the screen based on the screen information.

The voice guiding unit 56 generates and outputs the voice information for voice guidance to the user. When, for example, the screen is updated by the screen updating unit 54 based on the user's voice operation, the voice guiding unit 56 generates and outputs the voice information to provide the user with feedback of at least an updated part in the screen by voice. If the voice information based on the user's voice is received from the voice input device 3, the voice guiding unit 56 outputs the voice information to the voice input device 3 via the communication interface 23. After obtaining the voice information from the image processing device 2, the voice input device 3 outputs the voice based on the voice information.

It is assumed, for example, the user voices to the voice input device 3, “3 copies.” In this case, the image processing device 2 changes a value of the setting item of the “the number of copies” to “3” from a default value “1,” and updates the setting screen. The voice guiding unit 56 then, for instance, generates the voice information to voice “The number of copies is changed to 3.,” and sends the generated voice information to the voice input device 3. As a result, the voice input device 3 outputs the voice, “The number of copies is changed to 3.” from the speaker 43. Hence, the user is allowed to determine if the setting configured by voice is accurately reflected to the image processing device 2.

When the voice information based on the user's voice is obtained from the microphone 32 of the operational panel 16, the voice guiding unit 56 outputs the voice information for the voice guidance to the user to the speaker 33. To be more specific, the voice guiding unit 56 is enabled to switch the destination of the voice information for the voice guidance depending on a transmitter of the voice information based on the user's voice. When the user is operating by voice looking at the screen displayed on the display unit 30 of the operational panel 16, the voice for the voice guidance can be output from the speaker 33 of the operational panel 16.

The screen determinator 57 determines whether or not to display the screen updated by the screen updating unit 54 on the display unit 30. It is assumed, for example, the screen is updated by the screen updating unit 54 while the activation of the screen display function of the display unit 30 is terminated. In this case, the screen determinator 57 determines if it is necessary to display the updated screen on the display unit 30. However, this is given not for limitation. The screen determinator 57 may always determine the necessity of the display of the updated screen on the display unit 30 when the screen is updated based on the voice information received from the voice input device 3. The screen determinator 57 identifies the content of the display (hereafter, display content) of the screen updated by the screen updating unit 54, and determines whether or not to display the screen on the display unit 30 based on the display content.

To explain more in detail, when it is more preferable for the user to directly see the screen updated by the screen updating unit 54, the screen determinator 57 determines the updated screen is required to be displayed on the display unit 30. In contrast, when the screen updated by the screen updating unit 54 is not necessary to be seen by the user, the screen determinator 57 determines the updated screen is the screen not required to be displayed on the display unit 30.

Once the screen is updated by the screen updating unit 54, the aforementioned display voice guiding unit 56 at least generates the voice information to provide the user with feedback of the updated part in the screen by voice and outputs the generated voice information. In some cases, it is difficult to express the part updated by the screen updating unit 54 by voice. It is assumed, for example, that the user instructs to preview the image, and the screen is updated to the preview screen by the screen updating unit 54. In such a case, it is difficult to express the previewed image by voice, and the user cannot be provided with feedback that accurately reflects the content of the updated screen. The part updated by the screen updating unit 54 sometimes includes many different things and it takes long to reproduce the voice in order to express the whole updated part. It is sometimes difficult to provide the user with feedback of the whole updated part. It is assumed, for example, that the user instructs to switch the screen, and the screen is updated by the screen updating unit 54 to the screen including multiple setting items. In this case, it takes long to reproduce the voice to provide the user with feedback of all of the multiple setting items included in the updated screen by voice. It is difficult to accurately tell all of the multiple setting items to the user.

When it is possible to precisely express the part updated by the screen updating unit 54 by voice and the time to reproduce by voice is less than a predetermined period of time, it is possible to provide with feedback by voice. The screen determinator 57, therefore, determines the updated screen is not necessary to be displayed on the display unit 30. On the other hand, when it is difficult to accurately express the part updated by the screen updating unit 54 by voice or the time to reproduce the voice takes more than the predetermined period of time, it is difficult to provide with feedback by voice. The screen determinator 57, therefore, determines the updated screen should be displayed on the display unit 30. The screen determinator 57 outputs the determination result to each of the display controller 55, the voice guiding unit 56 and the user status determinator 58.

When the screen determinator 57 determines that the updated screen is necessary to be displayed on the display unit 30, the display controller 55 updates the screen to display on the display unit 30 based on the updated screen information received from the screen updating unit 54 and displays the updated screen. While the activation of the screen display function of the display unit 30 is terminated, the display controller 55 does not immediately display the updated screen on the display unit 30. The display controller 55 stores the screen information relating to the updated screen received from the screen updating unit 54 in the screen storage 38 and manages. When a predetermined condition is met, the display controller 55 effectively activates the screen display function of the display unit 30, and reads the screen information in the screen storage 38 to display on the display unit 30.

When the screen determinator 57 determines the updated screen is necessary to be displayed on the display unit 30, the voice guiding unit 56 generates the voice information for the voice guidance to promote the user to check the screen displayed on the display unit 30, and outputs the generated voice information. When the user is inputting the voice to the voice input device 3, the voice guiding unit 56 sends the voice information for voice guidance to the voice input device 3. The user, therefore, is allowed to recognize it is preferable to move to the installation site of the image processing device 2 and check the screen displayed on the operational panel 16 by listening to the voice guidance output from the voice input device 3.

When the screen determinator 57 determines the updated screen is necessary to be displayed on the display unit 30, the user status determinator 58 determines if the user who is operating by voice is allowed to see the display unit 30 of the operational panel 16. The user status determinator 58 determines if the user is allowed to see the display unit 30 based on information received from at least one of the human detection sensor 18, the microphone 32 of the operational panel 16, the photographing unit 17 and the panel posture detector 26.

When the human is detected within the range of the predetermined distance in the front side of the image processing device 2 by the human detection sensor 18, the user status determinator 58, for instance, may determine that the user is allowed to see the display unit 30. In this case, however, it is not enabled to identify whether or not the human detected by the human detection sensor 18 is the user who is operating the image processing device 2 by voice.

When the user's voice is detected by the microphone 32 of the operational panel 16, the user status determinator 58, for instance, may determine that the user is allowed to see the display unit 30. In one or more embodiments, the the user status determinator 58 may determine that the user is allowed to see the display unit 30 if the voice equal to or higher than a predetermined volume is detected by the microphone 32. If the voice is equal to or higher than the predetermined volume, it may be considered that the user is somewhere near the image processing device 2. When the microphone 32 includes the multiple microphones, the user status determinator 58 may detect a direction where the voice is output based on the volume detected by the multiple microphones so that a direction of the user is identified. When the user is in front of the operational panel 16, the user status determinator 58 may determine that the user is allowed to see the display unit 30. When the user's voice is detected by the microphone 32, the user status determinator 58 may perform a voiceprint authentication based on the voice. The voiceprint authentication enables to determine if the voice detected by the microphone 32 is the voice of the user who is currently operating by voice. The user status determinator 58 may output the voice information based on the voice detected by the microphone 32 to the user authenticating unit 52 and request the user authenticating unit 52 for the voiceprint authentication.

The user status determinator 58 may drive the photographing unit 17 to photograph the face image of the user who operates the operational panel 16 and determine if the user is allowed to see the display unit 30. The user status determinator 58, for example, extracts the face image from the photographic image obtained by the photographing unit 17. When the face image cannot be extracted from the photographic image, it means the user is not allowed to see the display unit 30. When the face image can be extracted from the photographic image, the user status determinator 58 performs a face authentication based on the face image to determine if a user who is in the photographic image matches with the user who operates by voice. The user who is in the photographic image may match with the user who operates by voice. In this case, the user status determinator 58 determines that the user who operates by voice is allowed to see the display unit 30.

The user status determinator 58 may identify a direction in which the user is looking by analyzing the face image, and determine that the user who operates by voice is allowed to see the display unit 30 when the user's eyes are looking at the display unit 30. The user status determinator 58 may identify a direction in which the display unit 30 is displaying based on the posture of the operational panel 16 detected by the panel posture detector 26, and determine that the user who operates by voice is allowed to see the display unit 30 when the direction in which the user is looking and the direction in which the display unit 30 is displaying match with each other.

After detecting that the user who was remotely operating via the voice input device 3 moves to the installation site of the image processing device 2 and is enabled to see the display unit 30, the user status determinator 58 instructs the display controller 50 to display the screen. When the activation of the screen display function of the display unit 30 is not terminated and the screen has already been displayed on the display unit 30, the user status determinator 58 is not required to perform the determination. The determination by the user status determinator 58 is carried out at least when the activation of the screen display function of the display unit 30 is terminated.

The display controller 55 effectively activates the screen display function of the display unit 30 based on the instruction from the user status determinator 58. The display controller 55 reads the screen information in the screen storage 38, and displays the screen based on the read screen information on the display unit 30. As a result, the screen which makes difficult to provide with feedback by voice can be seen by the user, and the information may be accurately provided to the user.

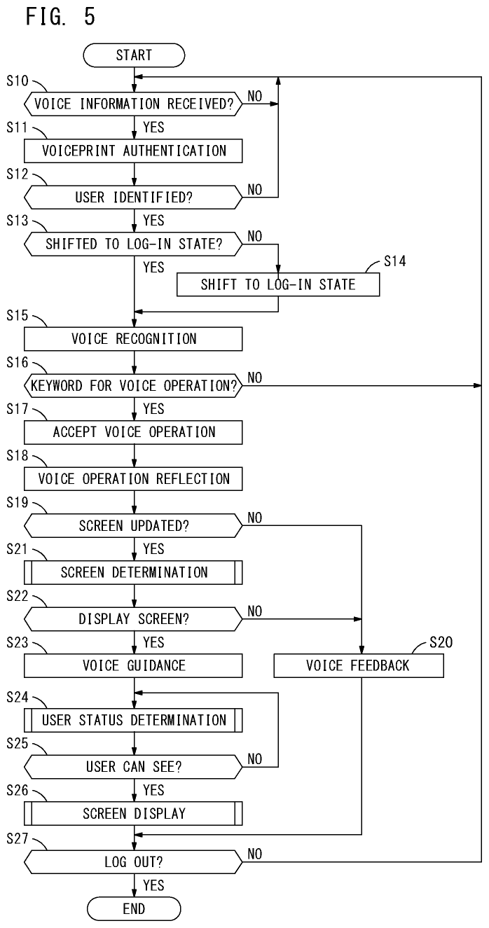

A process sequence performed in the image processing device 2 is explained next. FIG. 5 illustrates a flow diagram explaining an exemplary procedure of a process performed by the image processing device 2. This process is performed when the program 35 is executed by the CPU 21 of the controller 20 of the image processing device 2. Upon the start of the process, the image processing device 2 determines if the voice information is received from the voice input device 3 (step S10). When the voice information is not received (when a result of step S10 is NO), the image processing device 2 waits until receiving the voice information. In response to receiving the voice information from the voice input device 3 (when a result of step S10 is YES), the image processing device 2 performs the voiceprint authentication based on the received voice information (step S11), and determines if the user could be identified (step S12). When the user cannot be identified (when a result of step S12 is NO), the process by the image processing device 2 returns to step S10. When the user could be identified (when a result of step S12 is YES), the image processing device 2 determines if it has shifted to the log-in state (step S13). The image processing device 2 may have not been shifted to the log-in state (when a result of step S13 is NO). In this case, the image processing device 2 shifts to the log-in state in which the user identified through the voiceprint authentication logs in as a log-in user (step S14). The image processing device 2 may have already been shifted to the log-in state in which the user identified through the voiceprint authentication logs in as the log-in user (when a result of step S13 is YES). In such a case, the image processing device 2 skips the process in step S14.

After shifting to the log-in state, the image processing device 2 performs a voice recognition based on the voice information received in step S10 (step S15), and determines if the voice uttered by the user matches with the keyword for voice operation (step S16). If the voice uttered by the user does not match with the keyword for voice operation (when a result of step S16 is NO), the image processing device 2 does not accept the voice information as the voice operation. The process by the image processing device 2 then returns to step S10.

When the voice uttered by the user matches with the keyword for voice operation (when a result of step S16 is YES), the image processing device 2 accepts the voice information as the voice operation (step S17). The image processing device 2 then performs a voice operation reflection to reflect the voice operation performed by the user to the inside of the device (step S18). In the voice operation reflection, the job setting, for example, is configured based on the user instruction by the job manager 53. Also, in the voice operation reflection, the screen to be displayed on the display unit 30 is updated as required by the screen updating unit 54.

After the voice operation reflection, the image processing device 2 determines whether or not the screen is updated by the screen updating unit 54 (step S19). The screen may not be updated (when a result of step S19 is NO). In this case, the image processing device 2 performs a voice feedback to provide the user with feedback of the process result based on the user's voice operation by voice (step S20). It is assumed, for example, that the job manager 53 starts the processing of the job based on the user's voice operation. The image processing device 2 then generates the voice information to output the voice such as “The job processing is started.,” for example, and sends the generated voice information to the voice input device 3.

When the screen is updated by the screen updating unit 54 (when a result of step S19 is YES), the image processing device 2 brings the screen determinator 57 into operation to perform a screen determination (step S21). In the screen determination, the screen determinator 57 determines if it is necessary to display the updated screen on the display unit 30. The detail of the screen determination (step S21) is described later.

The image processing device 2 determines whether or not to display the screen as a result of the screen determination (step S22). If the screen updated by the screen updating unit 54 is not necessary to be displayed on the display unit 30 (when a result of step S22 is NO), the image processing device 2 performs the voice feedback (step S20). It is assumed, for example, that the setting value of one of the setting items is changed from the default value by the user by voice. The image processing device 2 then generates the voice information to provide the user with feedback of the setting value after the setting change by voice, and sends the voice information to the voice input device 3.

When the screen updated by the screen updating unit 54 is necessary to be displayed on the display unit 30 (when a result of step S22 is YES), the image processing device 2 outputs the voice guidance to prompt the user to check the screen displayed on the display unit 30 (step S23). The user then is enabled to recognize it is necessary to check the screen displayed on the operational panel 16 of the image processing device 2.

After outputting the voice guidance to the user, the image processing device 2 brings the user status determinator 58 into operation to perform a user status determination (step S24). To be more specific, the image processing device 2 determines if the user who is operating by voice is allowed to see the screen displayed on the display unit 30 of the operational panel 16. The detail of the user status determination (step S24) is explained later. The image processing device 2 may determine that the user is allowed to see the display unit 30 as a result of the user status determination (when a result of step S25 is YES). In such a case, the image processing device 2 performs a screen display (step S26). To be more specific, the display controller 55 effectively activates the screen display function of the display unit 30 and displays the screen updated by the screen updating unit 54 on the display unit 30. Hence, the user sees the screen displayed on the display unit 30 so that he or she is enabled to visually check that the his or her voice operation is reflected. The detail of the screen display (step S26) is explained later.

The image processing device 2 then determines if the user operates to log out (step S27). When the user operates to log out (when a result of step S27 is YES), the process by the image processing device 2 completes. When the user does not operate to log out (when a result of step S27 is NO), the process by the image processing device 2 returns to step S10 to repeatedly perform the above-described process.

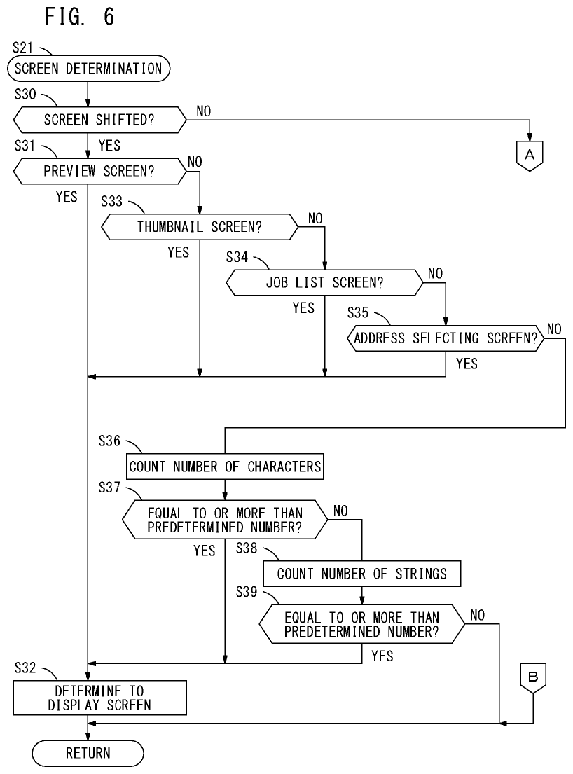

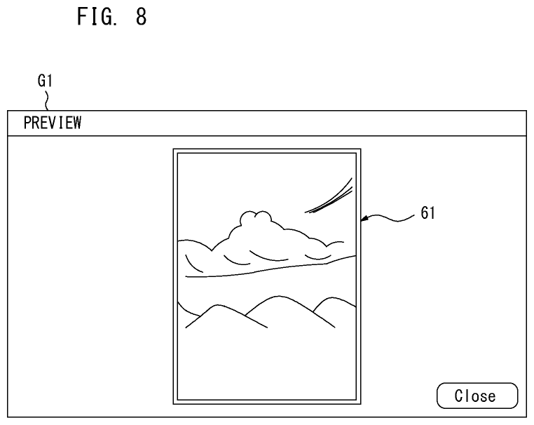

FIG. 6 illustrates a flow diagram explaining an exemplary procedure of the screen determination (step S21) in detail. The screen determination is performed by the above-described screen determinator 57. Upon starting the screen determination (step S21), the screen determinator 57 determines if the screen previously displayed has shifted to another screen due to the screen update (step S30). The screen may have had shifted due to the screen update (when a result of step S30 is YES). In this case, the screen determinator 57 determines if the shifted screen is the preview screen (step S31). FIG. 8 illustrates an example of a preview screen G1. In the preview screen G1, an image 61 specified by the user is previewed as illustrated in FIG. 8. The user, for example, selects the single image 61 and instructs to preview the selected image 61. The preview screen G1 as illustrated in FIG. 8 is then displayed by the screen updating unit 54. The preview screen G1 enables the user to check the image 61. The detail of the image 61 previewed in the preview screen G1 cannot be expressed in detail by voice. When the shifted screen is the preview screen G1 (when a result of step S31 is YES), the screen determinator 57 determines it is necessary to display the screen updated by the screen updating unit 54 on the display unit 30 (step S32).

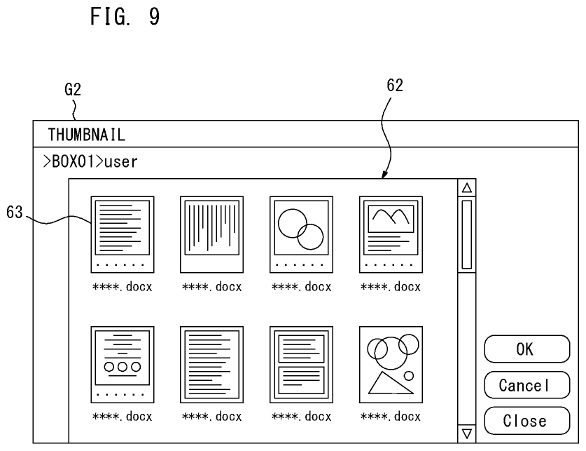

If the shifted screen is not the preview screen G1 (when a result of step S31 is NO), the screen determinator 57 determines if the shifted screen is a thumbnail screen (step S33). FIG. 9 illustrates an example of a thumbnail screen G2. The thumbnail screen G2 includes a thumbnail area 62 as illustrated in FIG. 9. A thumbnail image 63 of the electronic file stored in the file storage 36 designated by the user is displayed in the thumbnail area 62 in the thumbnail screen G2. More than one electronic file may be stored in the file storage 36. In this case, the thumbnail images 63 of the respective electronic files are arranged at regular intervals in the thumbnail area 62. The user operates the thumbnail image 63 displayed in the thumbnail area 62 so that he or she may select at least one of the electronic files among from the multiple electronic files. The thumbnail image 63 displayed in the thumbnail screen G2 cannot be expressed in detail by voice. When the shifted screen is the thumbnail screen G2 (when a result of step S33 is YES), the screen determinator 57 determines it is necessary to display the screen updated by the screen updating unit 54 on the display unit 30 (step S32).

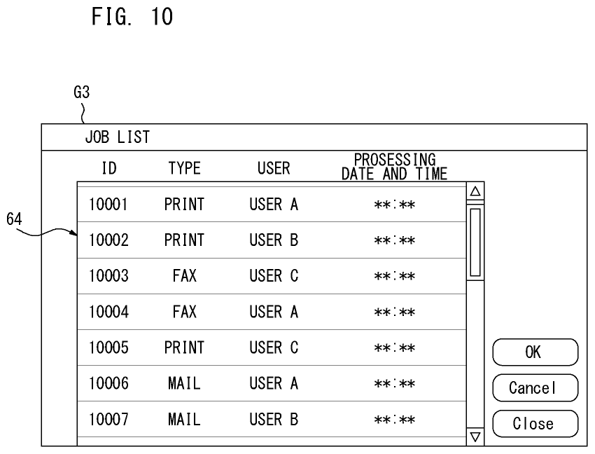

If the shifted screen is not the thumbnail screen G2 (when a result of step S33 is NO), the screen determinator 57 determines if the shifted screen is a job list screen (step S34). FIG. 10 illustrates an example of a job list screen G3. The job list screen G3 includes a job list area 64 as illustrated in FIG. 10. Information relating to at least one job may be displayed in the job list area 64. It is assumed, for example, the user instructs to display a job list while multiple jobs are registered in the job storage 37. In such a case, the screen updating unit 54 obtains the information relating to the respective multiple registered jobs in the job storage 37 and creates the job list screen G3 as illustrated in FIG. 10. The screen updating unit 54 then updates the previous screen to the job list screen G3. If the information relating to the single registered job is displayed in the job list area 64, the user may be provided with feedback by voice. If the information relating to the multiple registered jobs is displayed in the job list area 64 as illustrated in FIG. 10, the time to reproduce the voice gets long. In this case, the user may not be provided with feedback by voice. When the shifted screen is the job list screen G3 (when a result of step S34 is YES), the screen determinator 57 determines it is necessary to display the screen updated by the screen updating unit 54 on the display unit 30 (step S32).

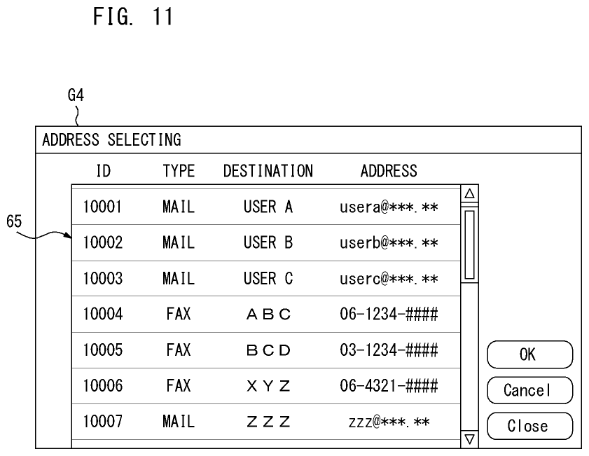

If the shifted screen is not the job list screen G3 (when a result of step S34 is NO), the screen determinator 57 determines if the shifted screen is an address selecting screen (step S35). FIG. 11 illustrates an example of an address selecting screen G4. The address selecting screen G4 includes an address area 65 as illustrated in FIG. 11. Information relating to at least one address may be displayed in the address area 65. It is assumed, for example, information of multiple addresses is registered in advance with the image processing device 2. The information of the multiple addresses is displayed in the address area 65. If only the information of the single address is displayed in the address area 65, the user may be provided with feedback of the address information by voice. If the information of the multiple addresses is displayed in the address area 65 as illustrated in FIG. 11, the time to reproduce the voice gets long. In this case, the user may not be provided with feedback by voice. When the shifted screen is the address selecting screen G4 (when a result of step S35 is YES), the screen determinator 57 determines it is necessary to display the screen updated by the screen updating unit 54 on the display unit 30 (step S32).

If the shifted screen is not the address selecting screen G4 (when a result of step S35 is NO), the screen determinator 57 counts the number of characters contained in the shifted screen (step S36), and determines if the number of the contained characters is equal to or more than the predetermined number (step S37). When the number of the characters contained in the shifted screen is equal to or more than the predetermined number, the time to reproduce the voice for feedback gets long. It is possible that the user cannot completely understand the feedback information. When the shifted screen contains the characters equal to or more than the predetermined number (when a result of step S37 is YES), the screen determinator 57 determines it is necessary to display the screen updated by the screen updating unit 54 on the display unit 30 (step S32). Any number may be configured as the predetermined number. Approximately 100 characters may be set in advance, for instance.

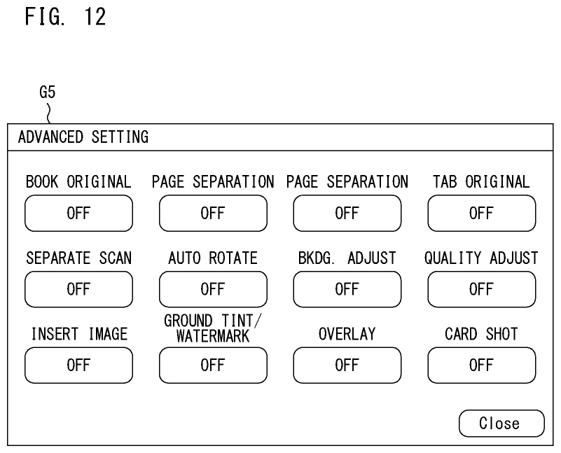

FIG. 12 illustrates an example of an advanced setting screen G5. When the user instructs to configure advanced settings, for instance, the screen is shifted to the advanced setting screen G5 from the previous screen. Many setting items are included in the advanced setting screen G5. Characters showing a name of each setting item and characters showing the current setting values of the respective setting items are included. The screen determinator 57 calculates the number of characters included in the advanced setting screen G5, and determines if the number of characters is equal to or more than the predetermined number.

When the shifted screen does not contain the characters equal to or more than the predetermined number (when a result of step S37 is NO), the screen determinator 57 counts the number of strings contained in the shifted screen (step S38), and determines if the number of strings is equal to or more than the predetermined number (step S39). When the number of the strings contained in the shifted screen is equal to or more than the predetermined number, the time to reproduce the voice for feedback gets long. It is possible that the user cannot completely understand the feedback information. When the shifted screen contains the strings equal to or more than the predetermined number (when a result of step S39 is YES), the screen determinator 57 determines it is necessary to display the screen updated by the screen updating unit 54 on the display unit 30 (step S32). Any number may be configured as the predetermined number. Approximately 10 may be set in advance, for instance. The advanced setting screen G5 as illustrated in FIG. 12 contains many setting items and many strings. When the screen is shifted to the advanced setting screen G5 as illustrated in FIG. 12 by the screen updating unit 54, the screen determinator 57 determines it is necessary to display the advanced setting screen G5 on the display unit 30 (step S32).

When the shifted screen contains the strings less than the predetermined number (when a result of step S39 is NO), the screen determinator 57 does not perform the process in step S32. The screen determinator 57 then determines it is not necessary to display the shifted screen on the display unit 30.

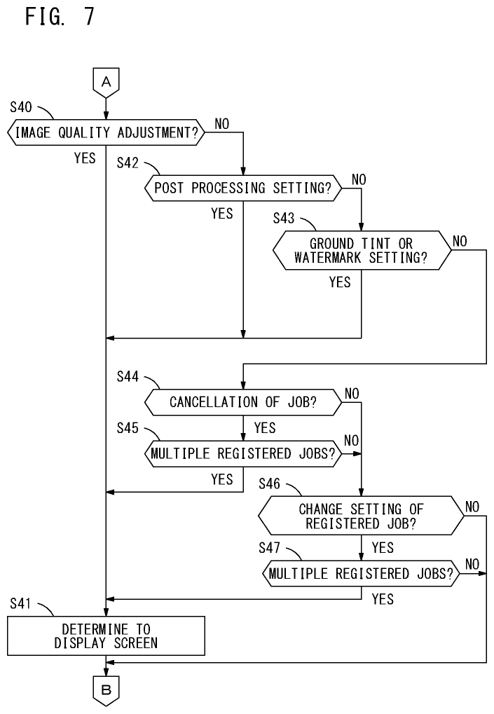

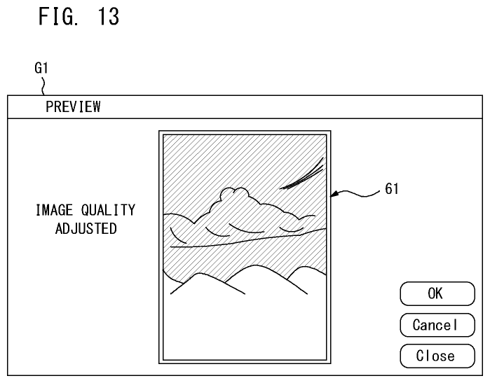

The screen may not be shifted and be updated by the screen updating unit 54 (when a result of step S30 is NO), the screen determinator 57 moves to the process of FIG. 7. The screen determinator 57 determines if the image quality of the image is adjusted based on the user's instruction (step S40). When the user instructs to adjust the image quality of the image 61 included in the preview screen G1 as illustrated in FIG. 13, for instance, the screen updating unit 54 updates the image 61 in the preview screen G1 based on the image, the quality of which is adjusted by the image processor 24. In the example of FIG. 13, a part of colors of the image is converted to another color. When the quality of the image 61 is adjusted, it is difficult to express what part of the image 61 is changed in what way by voice. When the adjustment of the image quality is instructed by the user and the image in the screen is updated by the screen updating unit 54 (when a result of step S40 is YES), the screen determinator 57 determines it is necessary to display the screen updated by the screen updating unit 54 on the display unit 30 (step S41).

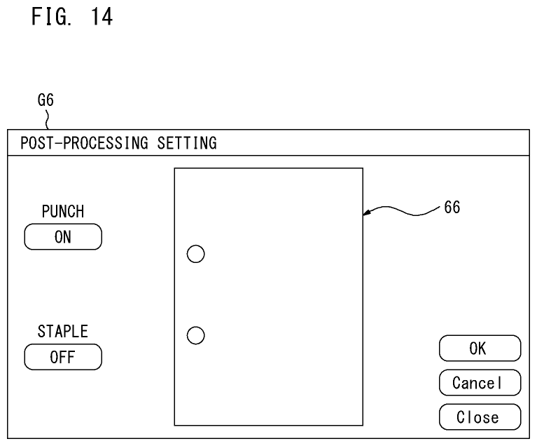

When the quality of the image is not adjusted (when a result of step S40 is NO), the screen determinator 57 determines if the setting of the post processing is configured based on the user's instruction (step S42). The settings of the post processing include, for example, stapling and/or punching of a sheet. When stapling or punching the sheet, a post processing setting screen is created by the screen updating unit 54. The user sees the post processing screen to check a stapling position or a punching position. FIG. 14 is an example of a post processing setting screen G6. When the user configures to punch, for example, the screen updating unit 54 adds an image component which shows a default punching position to a sheet image 66 and updates the post processing setting screen G6. The user operates the post processing setting screen G6 so that he or she is allowed to change the default punching position and specify another position. It is difficult to express the punching position of the sheet by voice. When the post processing setting is configured by the user (when a result of step S42 is YES), the screen determinator 57 determines it is necessary to display the screen updated by the screen updating unit 54 on the display unit 30 (step S41).

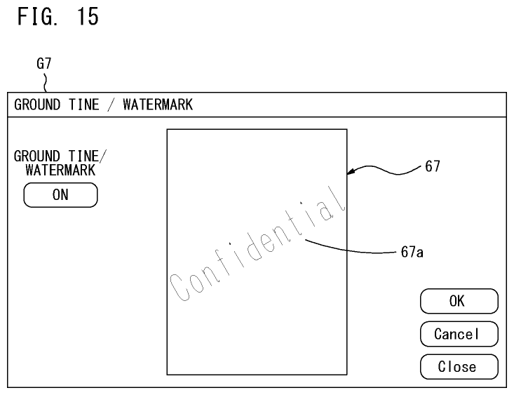

When the post processing setting is not configured (when a result of step S42 is NO), the screen determinator 57 determines if the screen is updated to the screen for the setting to superimpose a ground tint or a watermark on a print subjected image during the setting of the print job (step S43). FIG. 15 is an example of a screen G7 through which the user is enabled to configure the setting of the ground tint or the watermark. When the user configures to enable the setting of the item of the ground tint or the watermark on, for example, the screen updating unit 54 adds a default image component 67a to a predetermined position of a sheet image 67 and updates the screen G7. The user operates the screen G7 so that he or she is allowed to change the image to add as the ground tint or the watermark or change the position to print the ground tint or the watermark. It is difficult to express the content or the printing position of the image component 67a to add to the sheet image 67 by voice. When the setting to superimpose the ground tint or the watermark on the print subjected image is configured by the user (when a result of step S43 is YES), the screen determinator 57 determines it is necessary to display the screen updated by the screen updating unit 54 on the display unit 30 (step S41).

When the setting of the ground tint or the watermark is not configured (when a result of step S43 is NO), the screen determinator 57 determines if the user's instruction is to cancel the registered job (step S44). If the user's instruction is to cancel the registered job (when a result of step S44 is YES), the screen determinator 57 determines if the multiple registered jobs are stored in the job storage 37 (step S45). The multiple registered jobs may be stored in the job storage 37. In this case, the image processing device 2 needs to identify the registered job to cancel from among the multiple registered jobs. The screen updating unit 54 then updates the screen to display on the display unit 30 to the screen that enables the user to select the registered job to cancel (the same screen as the job list screen G3 of FIG. 10, for instance). As described above, the multiple jobs may be registered (when a result of step S45 is YES) when the user instructs to cancel the registered job (when a result of step S44 is YES). In this case, the screen determinator 57 determines it is necessary to display the screen updated by the screen updating unit 54 on the display unit 30 as well as the case where the screen is shifted to the job list screen G3 of FIG. 10 (step S41).

When the user has not instructed to cancel the registered job (when a result of step S44 is NO), the screen determinator 57 determines if the user's instruction is to change the setting of the registered job (step S46). If the user's instruction is to change the setting of the registered job (when a result of step S46 is YES), the screen determinator 57 determines if the multiple registered jobs are stored in the job storage 37 (step S47). The multiple registered jobs may be stored in the job storage 37. In this case, the image processing device 2 needs to identify the registered job to change the setting from among the multiple registered jobs. The screen updating unit 54 then updates the screen to display on the display unit 30 to the screen to enable the user to select the registered job to change the setting (the same screen as the job list screen G3 of FIG. 10, for instance). The multiple jobs may be registered (when a result of step S47 is YES) when the user instructs to change the setting of the registered job (when a result of step S46 is YES). In this case, the screen determinator 57 determines it is necessary to display the screen updated by the screen updating unit 54 on the display unit 30 as well as the case where the screen is shifted to the job list screen G3 of FIG. 10 (step S41).

When the user has not instructed to change the setting of the registered job (when a result of step S46 is NO) or the multiple registered jobs are not stored in the job storage 37 (when a result of step S47 is NO), the screen determinator 57 does not perform the process in step S41. The screen determinator 57 then determines it is not necessary to display the shifted screen on the display unit 30. As described above, the screen determination (step S21) completes.

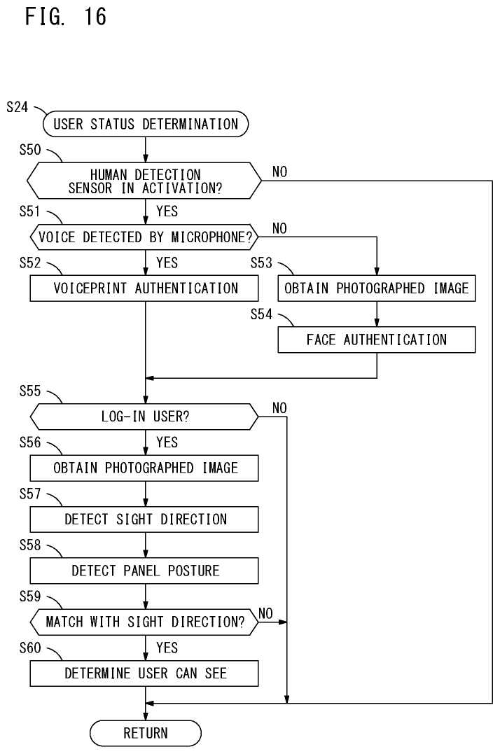

FIG. 16 illustrates a flow diagram explaining an exemplary procedure of the user status determination (step S24) in detail. The screen determination is performed by the above-described user status determinator 58. Upon starting the user status determination (step S24), the user status determinator 58 determines if the human detection sensor 18 is in activation (step S50). When the human detection sensor 18 is not in activation (when a result of step S50 is NO), it means there is no one in front of the image processing device 2. If the human detection sensor 18 is not in activation, there is no user who can see the display unit 30 so that the user status determination completes. When the human detection sensor 18 is in activation (when a result of step S50 is YES), there is someone in front of the image processing device 2. The user status determinator 58 then performs the process after step S51.

When the human detection sensor 18 is in activation, the user status determinator 58 determines if the voice is detected by the microphone 32 equipped with the operational panel 16 (step S51). In order to eliminate surrounding noise, the user status determinator 58 may determine if the voice equal to or higher than the predetermined volume is detected by the microphone 32. When the voice is detected by the microphone 32 (when a result of step S51 is YES), the user status determinator 58 performs the voiceprint authentication based on the voice information received from the microphone 32 (step S52). Through the voiceprint authentication, it is determined if the user who uttered the voice is the log-in user.

The voice may not be detected by the microphone 32 (when a result of step S51 is NO). In this case, the user status determinator 58 enables the photographing unit 17 to photograph and obtains the photographed image from the photographing unit 17 (step S53). The user status determinator 58 then extracts the face image of the user from the photographed image to perform the face authentication (step S54). The face authentication enables to determine if the user on the photographed image is the log-in user. If the face image cannot be extracted from the photographed image, the user who matches with the log-in user is not detected through the face authentication.

After performing the voiceprint authentication or the face authentication, the user status determinator 58 determines if the user matches with the log-in user is detected (step S55). If the user who matches with the log-in user is not detected (when a result of step S55 is NO), the user status determination completes.

The user who matches with the log-in user may be detected (when a result of step S55 is YES). In this case, the user status determinator 58 enables the photographing unit 17 to photograph and obtains the photographed image from the photographing unit 17 (step S56). If the photographed image has already been obtained in the aforementioned step S53, the process in step S56 may be skipped. The user status determinator 58 then extracts the face image of the user from the photographed image and analyzes the extracted face image to detect the direction in which the user is looking (step S57). The user status determinator 58 also detects the posture of the operational panel 16 based on the information received from the panel posture detector 26 (step S58). By detecting the posture of the operational panel 16, the user status determinator 58 identifies the direction in which the display unit 30 is displaying. More specifically, the user status determinator 58 determines if the display unit 30 is positioned in the posture that enables the user to see on the line that extends to the direction in which the user is looking. When the direction in which the user is looking and the direction in which the display unit 30 is displaying match with each other (when a result of step S59 is YES), the user status determinator 58 determines the user who operates by voice is allowed to see the display unit 30 (step S60). The direction in which the user is looking and the direction in which the display unit 30 is displaying may not match with each other (when a result of step S59 is NO). In such a case, the user status determinator 58 does not perform the process in step S60. The user status determinator 58 then determines that the user who operates by voice is not allowed to see the display unit 30. As described above, the user status determination (step S24) completes.

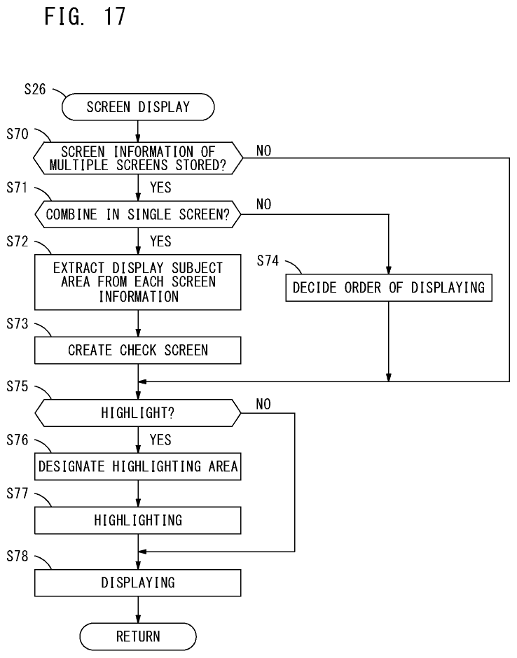

FIG. 17 illustrates a flow diagram explaining an exemplary procedure of the screen display (step S26) in detail. The screen display is performed by the above-described display controller 55. Upon starting the screen display (step S26), the display controller 55 determines if the screen information of the multiple screens is stored in the screen storage 38 (step S70). The screen information of the multiple screens is sometimes stored in the screen storage 38 while the user is remotely operating the image processing device 2 via the voice input device 3. The display controller 55, therefore, determines if the screen information of the multiple screens is stored in the screen storage 38 when the user becomes to be enabled to see the display unit 30.

When the screen information of only the single screen is stored in the screen storage 38 (when a result of step S70 is NO), the process by the display controller 55 moves on to step S75. The screen information of the multiple screens may be stored in the screen storage 38 (when a result of step S70 is YES). In this case, the display controller 55 determines if the multiple screens should be combined in the single screen (step S71). If the number of screens stored in the screen storage 38 is less than a predetermined number, for example, the display controller 55 determines the screen information of the multiple screens can be combined in the single screen. The number of the screens stored in the screen storage 38 may be more than the predetermined number. The display controller 55 then determines not to combine in the single screen. The predetermined number may be set as required. Approximately 3 screens may be set in advance as the predetermined number, for instance.

The display controller 55 may determine to combine the screen information of the multiple screens in the single screen (when a result of step S71 is YES). In this case, the display controller 55 extracts display subjected areas from the screen information of the respective multiple screens stored in the screen storage 38 (step S72). If the screen is the preview screen G1, for instance, the display controller 55 extracts the previewed image part as the display subjected area. If the screen is the thumbnail screen G2, for instance, the display controller 55 extracts the thumbnail area as the display subjected area. As described above, the display controller 55 only extracts the area requiring the user's check from among the whole screen. The display controller 55 creates a check screen in which the display subjected areas extracted in step S72 is arranged in the single screen (step S73).

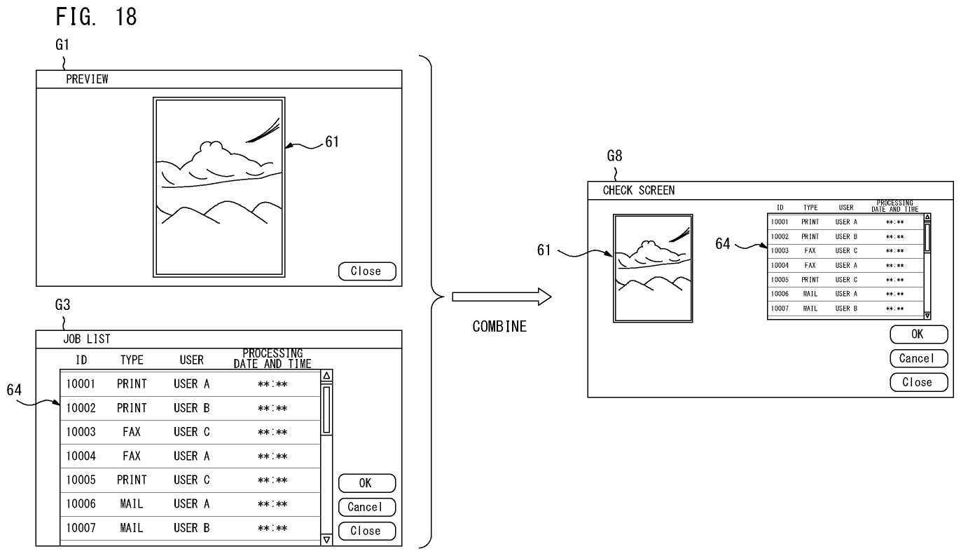

FIG. 18 illustrates an example of the check screen G8 created by the display controller 55. The check screen G8 of FIG. 18 is created by combining the two screens, the preview screen G1 and the job list screen G3. As illustrated in FIG. 18, the display controller 55 extracts the image 61 from the preview screen G1 as the display subjected area and the job list area 64 from the job list screen G3 as the display subjected area. The display controller 55 creates the check screen G8 in which the image 61 and the job list area 64 are arranged in the single screen. The display controller 55 may reduce the image 61 and the job list area 64 in size as required to arrange them in the single screen. Also, the display controller 55 may create the check screen G8 scrollable in the vertical direction and the horizontal direction and arrange the multiple display subjected areas without reduction in size.

The display controller 55 may determine not to combine the screen information of the multiple screens in the single screen (when a result of step S71 is NO). In this case, the display controller 55 decides an order of displaying the screen information of the multiple screens stored in the screen storage 38 (step S74). The display controller 55 may decide the order of reading from the latest screen information stored in the screen storage 38 in the most recent. In this case, the user is allowed to check from the screen which reflects the current operation. However, this is given not for limitation. The display controller 55 may decide the display order in the order of storage in the screen storage 38.

The display controller 55 determines whether or not to highlight the screen (step S75). It is set in advance whether or not to highlight the screen, for example. The display controller 55 determines whether or not to highlight based on the setting. When not highlighting (when a result of step S75 is NO), the process by the display controller moves on to step S78. For highlighting (when a result of step S75 is YES), the display controller 55 designates a highlighting area (step S76). The display controller 55, for instance, designates the area that should be noted by the user as the highlighting area. The display controller 55 highlights the designated highlighting area (step S77).

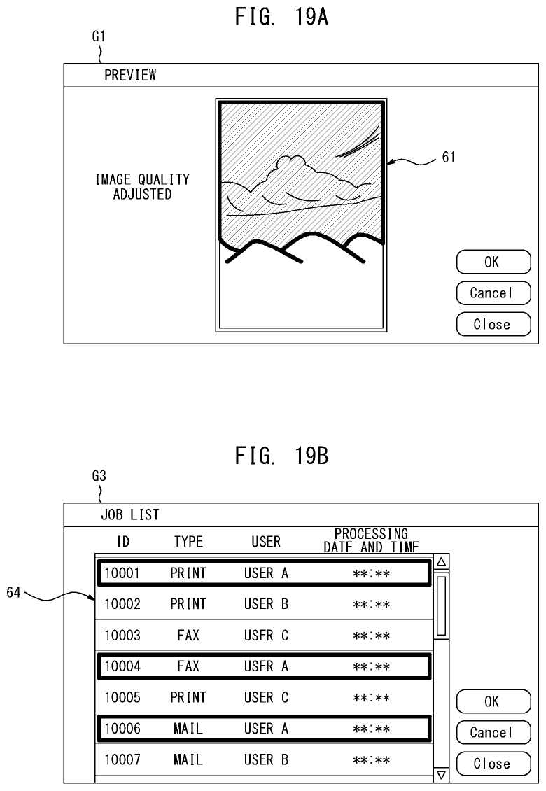

FIGS. 19A and 19B illustrate a concept of highlighting the screen. As illustrated in FIG. 19A, for instance, the image quality of the image 61 in the preview screen G1 is adjusted based on the user's instruction. The display controller 55 then identifies the part, the image quality of which is adjusted, in the image 61 as the highlighting area. The display controller 55 highlights by thickening an outer edge of the highlighting area to create the screen notable by the user.

As illustrated in FIG. 19B, for instance, when a user A instructs to cancel the registered job, the display controller 55 designates the area which shows the job registered by the user A among from the multiple registered jobs included in the job list screen G3 as the highlighting area. More than one highlighting area may be designated from the single screen. The display controller 55 highlights by thickening an outer edge of the highlighting area to create the screen notable by the user.

The display controller 55 then displays the screen obtained as described above on the display unit 30 (step S78). While the activation of the screen display function of the display unit 30 is terminated, for example, the display controller 55 effectively activates the screen display function of the display unit 30 in step S78 to display the screen that requires the user's check on the display unit 30. When the displaying order is decided in step S74, for example, the display controller 55 updates the screen on the display unit 30 every predetermined period of time in accordance with the displaying order.

The screen is displayed on the display unit 30 in step S78 so that the user is allowed to check the screen updated based on his or her operation by voice. The user sees the screen and is allowed to grasp easily even the information that cannot be told correctly with feedback by voice.

It is assumed that the user remotely operates the image processing device 2 by voice and instructs to perform the process by voice. The information processing system 1 of one or more embodiments then provides the user with feedback of a result of the process by voice. Sometimes, it is difficult to tell the result of the process to the user correctly with feedback by voice. The information processing system 1 updates the screen to display on the display unit 30 one after another based on the voice operation by the user and determines if it is necessary for the user to check the content of the screen by displaying the updated screen on the display unit 30. Once determining it is necessary for the user to check the content of the screen, the information processing system 1 prompts the user to check the screen and displays the screen that reflects the voice operation by the user on the display unit 30. The information processing system 1 enables to tell precisely the information that should be provided as feedback to the user even when it is difficult to provide the user with feedback by voice while the user performs the voice operation.

When the voice operation is received from the user while the user is allowed to see the display unit 30, the image processing device 2 may switch the transmitter of the voice from the voice input device 3 to the microphone 32 equipped with the operational panel 16.

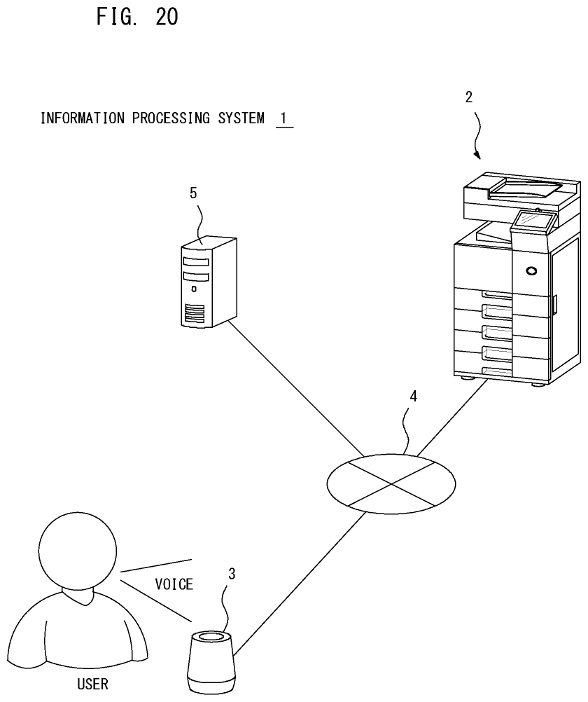

One or more embodiments of the present invention will be explained next. FIG. 20 illustrates an exemplary conceptual configuration of the information processing system 1 according to one or more embodiments of the present invention. The information processing system 1 of FIG. 20 includes the image processing device 2, the voice input device 3 and a server 5. The image processing device 2, the voice input device 3 and the server 5 are connected to enable communication with each other over the network 4.

The server 5 of one or more embodiments is equipped with a part of functions of the image processing device 2 as described in the above embodiments. The server 5, for example, includes the function of the screen determinator 57 as described in the above embodiments. Upon detecting the user's voice, the voice input device 3 generates the voice information based on the voice and sends the generated voice information to the image processing device 2 and the server 5. In response to receiving the voice information from the voice input device 3, the server 5 determines if the voice information is to operate the image processing device 2 by voice. If it is the voice operation, the server 5 brings the screen determinator 57 into operation. The server 5 brings the screen determinator 57 into operation to determine if it is necessary to display the screen updated by the screen updating unit 54 of the image processing device 2 on the display unit 30. The server 5 then sends a result of the determination by the screen determinator 57 to the image processing device 2.

The image processing device 2 does not include the function of the screen determinator 57. In response to receiving the voice information from the voice input device 3, the image processing device 2 determines if it is the voice operation. If it is the voice operation, the image processing device 2 reflects the content of the voice operation. The screen updating unit 54 becomes operative in the image processing device 2 to update the screen to display on the display unit 30. The display controller 55 determines whether or not to display the screen updated by the screen updating unit 54 on the display unit 30 based on the determination result received from the server 5. If the server 5 determines it is necessary to display the screen on the display unit 30, the display controller 55 displays the screen updated by the screen updating unit 54 on the display unit 30 when the user becomes to be enabled to see the display unit 30.

As described above, the information processing system 1 enables the server 5 to determine the necessity of the display of the screen, resulting in reduction of a process burden on the image processing device 2.

The server 5 may further be equipped with the function of the screen updating unit 54 in addition to the function of the screen determinator 57. In this case, the server 5 is enabled to update the screen to display on the display unit 30 based on the voice information received from the voice input device 3. It is assumed that the user comes close to another image processing device 2 which is different form the image processing device 2 that the user is remotely operating and starts operating the operational panel 16. In this case, the server 5 sends the screen information of the updated screen to the image processing device 2 currently being operated by the user, and displays the screen on the display unit 30. The user is allowed to check the content of the voice operation with the image processing device 2 near him or her, resulting in enhanced convenience.

Everything else except for the above-described points are the same as those explained in the above embodiments.

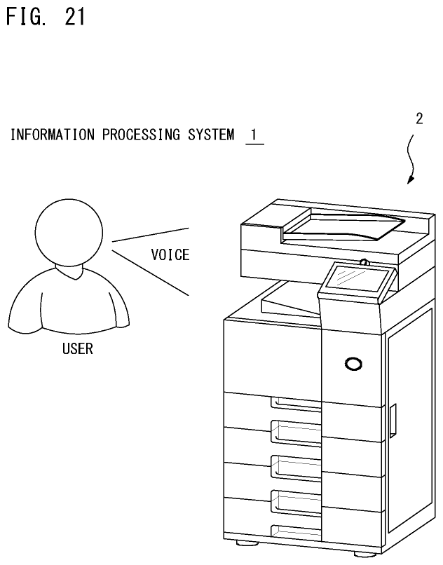

One or more embodiments of the present invention will be explained next. FIG. 21 illustrates an exemplary conceptual configuration of the information processing system 1 according to one or more embodiments of the present invention. To be more specific, the image processing device 2 is provided with the operational panel 16 with the microphone 32. The image processing device 2 is enabled to receive the user's voice detected by the microphone 32 as the voice operation. As described in the above embodiments, even the information processing system 1 does not include the voice input device 3, the image processing device 2 is enabled to form the information processing system 1 by itself to perform the operations as explained in the above embodiments.

Although the embodiments of the present invention have been described and illustrated in detail, it is clearly understood that the same is by way of illustration and example only and not limitation, the scope of the present invention should be interpreted by terms of the appended claims.

### (Modifications)

While the embodiments of the present invention have been described above, the present invention is not limited to the above embodiments. Various modifications may be applied to one or more embodiments of the present invention.

In the above-described embodiments, the image processing device 2 is constructed by a device such as the MFP including multiple functions such as the scan function, the print function, the copy function, the fax function, the box function and the email transmission and receipt function. The image processing device 2 does not have to include the multiple functions. The image processing device 2 may be a printer only including the print function, a scanner only including the scan function or a fax device only including the fax function. The image processing device 2 may be a device including a function except for the scan function, the print function, the copy function, the fax function, the box function and the email transmission and receipt function.

In the above-described embodiments, the voice input device 3 is a device called such as an AI speaker. However, this is given not for limitation. The voice input device 3 may be a user portable device such as a smartphone of a tablet terminal, for instance.

In the above-described embodiments, the program 35 executed by the CPU 21 of the controller 20 is stored in advance in the storage 28. The program 35 may be installed in the image processing device 2 via the communication interface 23, for example. In this case, the program 35 may be provided over an internet in a manner that enables a user to download, or may be provided in a manner that is recorded on a computer readable recording medium such as a CD-ROM or a USB memory.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprises:
a display; and
a hardware processor that:
receives user's voice as a voice operation;
updates a screen to be displayed on the display based on the received voice operation;
determines whether to display the updated screen on the display; and
displays the updated screen on the display upon determining to display the updated screen.

2. The information processing system according to claim 1, wherein the hardware processor further:
prompts a user to check the screen displayed on the display upon determining to display the updated screen.

3. The information processing system according to claim 1, wherein the hardware processor:
identifies a content to be displayed in the updated screen based on the received voice operation; and
determines whether to display the updated screen on the display based on the identified content.

4. The information processing system according to claim 1, wherein
the hardware processor determines to display the updated screen when the updated screen displays a preview of an image.

5. The information processing system according to claim 1, further comprising:
a file storage that stores an electronic file, wherein
the hardware processor determines to display the updated screen when the updated screen displays a thumbnail of the electronic file stored in the file storage.

6. The information processing system according to claim 1, further comprising:
an image processor that adjusts a quality of the image, wherein
the hardware processor determines to display the updated screen when the updated screen display the image with the adjusted quality.

7. The information processing system according to claim 1, further comprising:
a printer that prints an image on a sheet; and
a post processor that performs a post processing at a specified position of the sheet on which the image is printed by the printer, wherein
the hardware processor determines to display the updated screen when the updated screen specifies the position at which the post processing is performed by the post processor.

8. The information processing system according to claim 1, further comprising:
a printer that prints an image on a sheet, wherein
the hardware processor determines to display the updated screen when the updated screen enables a user to configure setting of imposing a ground tint or a watermark in printing by the printer.

9. The information processing system according to claim 1, wherein
the hardware processor determines to display the updated screen when the updated screen is a job list screen that displays a list of multiple jobs.

10. The information processing system according to claim 1, wherein
the hardware processor determines to display the updated screen when the updated screen is an address selecting screen that displays a list of multiple addresses.

11. The information processing system according to claim 1, wherein the hardware processor further:
registers a job and manages the registered job,
manages the multiple registered jobs, and
determines to display the updated screen in response to when the updated screen enables a user to select the registered job to be canceled from among the multiple registered jobs.

12. The information processing system according to claim 1, wherein
the hardware processor determines to display the updated screen in response to when the updated screen contains equal to or more than a predetermined number of characters or strings.

13. The information processing system according to claim 1, wherein the hardware processor further:
determines whether a user who uttered the voice received as the voice operation is allowed to see the display upon determining to display the updated screen, and
displays the updated screen on the display upon determining the user is allowed to see the display.

14. The information processing system according to claim 13, further comprising:
a voice input device, wherein
the hardware processor determines whether the user is allowed to see the display based on the voice detected by the voice input device.

15. The information processing system according to claim 13, further comprising:
a human detection sensor, wherein
the hardware processor determines whether the user is allowed to see the display based on a signal received from the human detection sensor.

16. The information processing system according to claim 13, further comprising:
a photographing device, wherein
the hardware processor determines whether the user is allowed to see the display based on an image photographed by the photographing device.

17. The information processing system according to claim 16, wherein the hardware processor:
extracts a face image from the image photographed by the photographing device;
identifies a direction in which the user is looking based on the extracted face image; and
determines that the user is allowed to see the display when the direction matches an installation direction of the display.

18. The information processing system according to claim 17, wherein
the display has a posture that is changeable, and
the hardware processor determines that the user is allowed to see the display in response to the direction identified based on the face image matching with a direction of displaying corresponding to the posture of the display.

19. The information processing system according to claim 1, further comprising:
a screen storage in which the updated screen is stored, wherein
the hardware processor reads the updated screen in the screen storage and displays the read screen on the display upon determining to display the updated screen.

20. The information processing system according to claim 19, wherein
the hardware processor displays each of the multiple screens one by one on the display when the multiple screens are stored in the screen storage.

21. The information processing system according to claim 19, wherein
the hardware processor preferentially reads the screen stored at last in the screen storage and displays the read screen on the display when the multiple screens are stored in the screen storage.

22. The information processing system according to claim 19, wherein the hardware processor:
cuts at least a part of a screen component out of each of the multiple screens when the multiple screens are stored in the screen storage; and
displays the screen in which the screen component cut out from each screen is combined in the single screen, on the display.

23. The information processing system according to claim 1, wherein
the hardware processor highlights at least a part of the updated screen upon displaying the updated screen on the display.

24. The information processing system according to claim 1, wherein
the information processing system is an image processing device that processes a job designated by a user.

25. The information processing system according to claim 1, further comprises:
an image processing device that processes a job designated by a user; and
a voice input device that detects the user's voice, wherein
the image processing device and the voice input device communicate with each other,
the image processing device comprises the display and the hardware processor, and
the voice input device outputs the user's voice to the image processing device.

26. The information processing system according to claim 1, further comprises:
an image processing device that processes a job designated by a user;
a voice input device that detects the user's voice; and
a server, wherein
the image processing device, the voice input device, and the server communicate with each other, and
the server comprises the hardware processor that displays the updated screen on the display based on a result of the determination in the server.

27. A non-transitory recording medium storing a computer readable program to be executed by a hardware processor in a computer comprising a display, the hardware processor executing the program to perform:
receiving user's voice as a voice operation;
updating a screen to be displayed on the display based on the received voice operation;
determining whether to display the updated screen on the display; and
displaying the updated screen on the display upon determining to display the updated screen.
